(19) United States
(12) Patent Application Publication
(10) Pub. No.: US 2021/0342767 A1
(43) Pub. Date: Nov. 4, 2021

(54) EXTERNALLY-CONNECTED SHOP FLOOR CONTROL SYSTEM

(71) Applicant: PRIMAX ELECTRONICS LTD., Taipei City (TW)

(72) Inventors: SHIH-CHIEH HSU, Taipei City (TW); WEI-LUNG HUANG, Taipei City (TW); PEI-MING CHANG, Taipei City (TW); PAO-CHUNG CHAO, Taipei City (TW); TZU-CHI TSENG, Taipei City (TW); CHIA-FENG LEE, Taipei City (TW)

(21) Appl. No.: 16/937,753

(22) Filed: Jul. 24, 2020

(30) Foreign Application Priority Data
Apr. 30, 2020 (TW) 109114591

(51) Int. Cl. G06Q 10/06; G05B 19/418

(52) U.S. Cl. CPC G06Q 10/06398; G05B 2219/32389; G05B 2219/32132; G05B 19/41865

(57) ABSTRACT

An externally-connected shop floor control (SFC) system comprising M shop floor control (SFC) devices is disclosed. By letting each of the M SFC devices be electrically connected between one test machine and one information read-out device, the SFC system is successfully implemented into a production line. Therefore, each of the M SFC devices is adopted to achieve a re-verification of pass record for a test object that is transferred from a previous-stage test machine, and is also adopted for collecting related test data of the test object transferred from a current-stage test machine. As such, the SFC system can be easily implemented into any one type of production line, so as to assist the manager of the production line in data collection, station passing control, manufacturing reports, and control of production efficiency and yield, without spending much cost of human resources and software/firmware developing.

### FIELD OF THE INVENTION

The present invention relates to the technology field of shop floor control (SFC), and in particular, to an externally-connected shop floor control system, which can be easily implemented into any one type of production line after some needed parameter setting is completed, so as to assist the manager of the production line in data collection, station passing control, manufacturing reports, and control of production efficiency and yield.

### BACKGROUND OF THE INVENTION

Shop floor control (SFC) is a specific system of methods and tools that are used to track, schedule and report on the progress of work in a production line. It is known that, a specific production line is particularly established for automatically completing the mass production of at least one specific product, and it needs to spend a few days or weeks for achieving a fabrication of the product by completing necessary manufacturing processes from beginning to end. For above reasons, SFC system is therefore implemented into the production line of a manufacturing plant, so as to be used for assisting the production line manager not only in recording and compiling information of raw materials, semi-finished products, products, machines, working hours, and costs, but also in the management of the production line in data collection, station passing control, manufacturing reports, and control of production efficiency and yield.

Therefore, let each of test stations that are arranged in the production line be equipped with a SFC system is known optimal, but there are many problems in practically executing that. First of all, manufacturing plant has to provide libraries and specific interfaces of each of the test stations to the SFC system developer, and also needs to let the SFC system developer know what SFC parameters are required by the test stations. In case of the plant manager and/or the plant director do not know how to provide relative materials to the SFC system developer, the manufacturing plant is responsible for assigning at least one IT staff to co-work with the SFC system developer. Second, in an initial developing stage, the SFC system installed in the test station is commonly only for satisfying the engineering verification test (EVT). It is extrapolated that, the SFC system for EVT fails to be comprehensively implemented into each of the test stations, thereby failing to assist the manager of the production line in data collection, station passing control, manufacturing reports, and control of production efficiency and yield. Third, compared to a SFC system with complete functionalities, the forgoing SFC system for EVT has a cheaper selling price but fails to exhibit a complete function of shop floor control. In such case, the manufacturing plant needs to pay extra functionalities developing and implementing fee to the SFC system developer, so as to let SFC system developer to establish a SFC system with complete functionalities in the production line.

From above descriptions, it is understood that there is still room for improvement in the conventional SFC system. In view of that, inventors of the present application have made great efforts to make inventive research and eventually provided an externally-connected shop floor control system.

### SUMMARY OF THE INVENTION

A primary objective of the present invention is to provide an externally-connected shop floor control system principally comprising M shop floor control (SFC) devices. After a basic parameter setting is completed for the M SFC devices according to relative information of M test machines that are arranged in a production line, each of the M SFC devices can be subsequently implemented into the production line by being electrically connected between one test machine and one information read-out device. Therefore, each of the M SFC devices is configured to achieve a re-verification of pass record for a test object that is transferred from a previous-stage test machine, and is also adopted for collecting related test data of the test object that is transferred from a current-stage test machine. As such, the externally-connected shop floor control system of the present invention can be easily implemented into any one type of production line, without spending much cost of human resources and software/firmware developing. As a result, the externally-connected shop floor control system is used for assisting the manager of the production line in data collection, station passing control, manufacturing reports, and control of production efficiency and yield.

To achieve the foregoing objective, the present invention provides one embodiment for the externally-connected shop floor control system, which is applied in a production line having M test machines and M information read-out devices, wherein each of the M information read-out devices is adopted for reading out an object information from a test object that is transferred into one of the M test machines, and the externally-connected shop floor control system comprises:

M shop floor control (SFC) devices, wherein each of the M SFC devices is connected between one of the M information read-out devices and one of the M test machines, and comprising:

a first communication interface for being coupled to the information read-out device;

a second communication interface for being coupled to the test machine;

a network communication interface; and

a data processing module, being coupled between the first communication interface and the second communication interface, and being coupled to the network communication interface; wherein there are a plurality of functional units provided in the data processing module, and the plurality of functional units comprising:

a device setting unit, being used for completing a parameter setting of the SFC device according to at least one machine information of the test machine;

a data acquiring unit, wherein before the test object is transferred into a N-th one of the M test machines for being executed an object testing, the data acquiring unit is, according to the object information transmitted from the information read-out devices, configured for acquiring a plurality of test data of the test object from a (N−1)-th one of the M SFC devices that is connected to a (N−1)-th one of the M test machines through the network communication interface; wherein the plurality of test data comprising a data of test result of the test object; and

a verification unit, wherein before the N-th one of the M test machines starts to execute the object testing for the test object, the verification unit applying a re-verification to a pass record from the data of test result, such that the N-th one of the M test machines is allowed to execute the object testing for the test object in case of the pass record having indicated that the object testing executed by the (N−1)-th one of the M test machines is passed;

wherein both M and N are an integer, and M being greater than N.

In the embodiment of the forgoing externally-connected shop floor control system, each of the M test machines is selected from the group consisting of appearance inspection machine, defect inspection machine, thickness measurement machine, function testing machine, and electronic test machine.

In the embodiment of the forgoing externally-connected shop floor control system, the test object is a semi-finished product or a product.

In the embodiment of the forgoing externally-connected shop floor control system, both the first communication interface and the second communication interface comprise a wireless transmission unit and/or a wired transmission unit.

In the embodiment of the forgoing externally-connected shop floor control system, a first one of the M test machines is disposed at a feed-in stage of the production line, and a first one of the M SFC devices that is connected to the first one of the M test machines not applying the re-verification to the pass record from the data of test result of the test object that is transferred into the first one of the M test machines.

In the embodiment of the forgoing externally-connected shop floor control system, a M-th one of the M test machines is disposed at a feed-out stage of the production line, and a M-th one of the M SFC devices that is connected to the M-th one of the M test machines acquiring all of the test data of the test object from a first one of the M SFC devices to a (M−1)-th one of the M SFC devices through the network communication interface thereof, so as to apply the re-verification to all of the pass records of the test object that is transferred into the M-th one of the M test machines.

In the embodiment of the forgoing externally-connected shop floor control system, the plurality of test data of the test object further comprises test station name, test station number, flow Number, serial number (SN), testing time, device name, device IP address, and device MAC address.

In the embodiment of the forgoing externally-connected shop floor control system, the test object is provided with an information carrying member for carrying the object information thereon.

In the embodiment of the forgoing externally-connected shop floor control system, the information carrying member is selected from the group consisting of 1D barcode, 2D barcode, QR code, Hanxin code, data matrix code, RFID tag, NFC tag, 1D symbology, and 2D symbology.

In the embodiment of the forgoing externally-connected shop floor control system, the information read-out device is selected from the group consisting of 1D barcode reader, 2D barcode reader, QR code reader, Hanxin code reader, data matrix code reader, RFID reader, NFC reader, and camera.

In one practicable embodiment of the forgoing externally-connected shop floor control system, the plurality of functional units provided in the data processing module further comprises a recording unit, being used for recording the object information that is read out by the information read-out device and the plurality of test data that are received from the (N−1)-th one of the M SFC devices that is connected to the (N−1)-th one of the M test machines.

In one practicable embodiment of the forgoing externally-connected shop floor control system, the plurality of functional units provided in the data processing module further comprises a storage unit, being used for storing the plurality of test data that comprise test station name, test station number, flow Number, serial number (SN), testing time, device name, device IP address, device MAC address, and the data of test result of the test object that are generated by the N-th one of the M test machines.

In the embodiment of the forgoing externally-connected shop floor control system, the data processing module is provided with a memory therein, and the memory including the recording unit and the storage unit.

In one practicable embodiment, the forgoing externally-connected shop floor control system further comprises a control center MED of the production line, which is coupled to the M SFC devices through a wireless connection interface or a wired connection interface, so as to not only control an operation state of each of the M SFC devices, but also assist a manager of the production line in data collection, station passing control, manufacturing reports, and control of production efficiency and yield based on all of the plurality of test data that are received from all of the M SFC devices.

In the embodiment of the forgoing externally-connected shop floor control system, the control center is an application program installed in an electronic device.

In one practicable embodiment of the forgoing externally-connected shop floor control system, the control center is selected from the group consisting of desk central control electronic system, cloud monitoring system, industrial computer, laptop computer, smartphone, and portable central control electronic system.

### BRIEF DESCRIPTION OF THE DRAWINGS

FIG. 1 shows a diagram for describing a production line including an externally-connected shop floor control system of the present invention.

FIG. 2 shows a block diagram of a shop floor control (SFC) device of the externally-connected shop floor control system according to the present invention.

### DETAILED DESCRIPTION OF THE PREFERRED EMBODIMENT

The advantages and features of an externally-connected shop floor control (SFC) system according to the present invention are described in details with reference to examples of embodiments and accompanying drawings to be more easily understood. However, the present invention may be implemented in different forms, and should not be construed as limited to only embodiments described herein. Conversely, for a person skilled in the art, the embodiments are provided for making the disclosure more thorough and comprehensive and completely conveying the scope of the present invention.

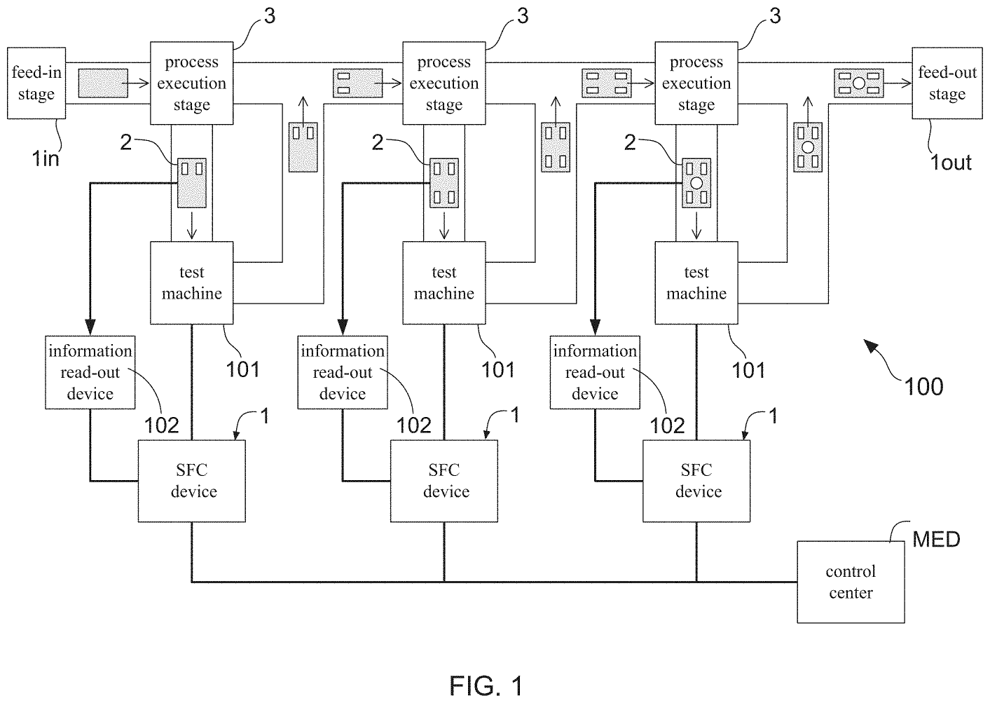

With reference to FIG. 1, there is provided a diagram for describing a production line including an externally-connected shop floor control system of the present invention. As FIG. 1 shows, the present invention discloses an externally-connected shop floor control system, which is for application in a production line 100 having M test machines 101 and M information read-out devices 102, wherein each of the M information read-out devices 102 is adopted for reading out an object information from an information carrying member that is provided on a test object 2 during the test object 2 being transferred into one of the M test machines 101. For example, FIG. 1 depicts that there are three process execution stages 3, three test machines 101 and three information read-out devices 102 arranged in the production line 100. After the test object 2 is completed a first manufacturing process by a first of the three process execution stages 3, the test object 2 is subsequently transferred to a first of the three test machines 101. In such case, a first of the three information read-out devices 102 read out an object information from the test object 2 before the test object 2 is transferred into the first test machine 101. It should be understood that, after being transferred out from any one of the three process execution stages 3, the test object 2 may be a product or a semi-finished product. Also, each of the M test machines 101 may be an appearance inspection machine, a defect inspection machine, a thickness measurement machine, a function testing machine, and an electronic test machine.

In one practicable embodiment, the forgoing information carrying member provided on the test object 2 can be a 1D barcode, a 2D barcode, a QR code, a Hanxin code, a data matrix code, a RFID tag, a NFC tag, a 1D symbology, and a 2D symbology. Accordingly, the information read-out device 102 would be a 1D barcode reader, a 2D barcode reader, a QR code reader, a Hanxin code reader, a data matrix code reader, a RFID reader, a NFC reader, and a camera.

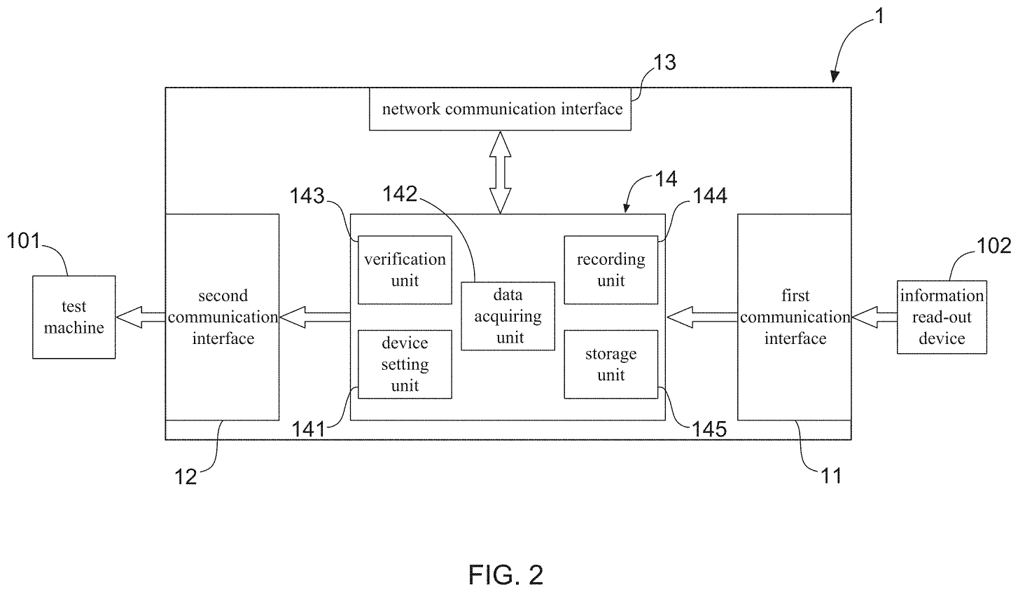

With reference to FIG. 1 again, and please refer to FIG. 2 showing a block diagram of a shop floor control (SFC) device of the externally-connected shop floor control system according to the present invention. In the present invention, the externally-connected shop floor control system principally comprises M shop floor control (SFC) devices 1, wherein each of the M SFC devices 1 is connected between one of the M information read-out devices 102 and one of the M test machines 101. Moreover, as FIG. 2 shows, the SFC device 1 comprises a first communication interface 11, a second communication interface 12, a network communication interface 13, and a data processing module 14. In which, the first communication interface 11 is for being coupled to the information read-out device 102, and the second communication interface 12 is for being coupled to the test machine 101. In one practicable embodiment, both the first communication interface 11 and the second communication interface 12 comprise a wireless transmission unit and/or a wired transmission unit. On the other hand, the data processing module 14 is coupled between the first communication interface 11 and the second communication interface 12, and is also coupled to the network communication interface 13.

Particularly, there are a plurality of functional units provided in the data processing module 14, and the plurality of functional units comprising a device setting unit 141, a data acquiring unit 142 and a verification unit 143. It is worth mentioning that, after using the device setting unit 141 to complete a basic parameter setting for a N-th one of the M SFC devices 1 according to relative information of a N-th one of the M test machines 101, a SFC functionality for the N-th test machine 101 is therefore installed. By such easy way, each of the M SFC devices can be all implemented into the production line 100 by being electrically connected between one test machine 101 and one information read-out device 102. Necessary parameters for the basic parameter setting include test station name, test station number, flow number, serial number (SN), device name, device IP address, and device MAC address.

After all of the M SFC devices 1 are successfully implemented into the production line 100, before the test object 2 is transferred into a N-th one of the M test machines 101 for being executed an object testing, the data acquiring unit 142 of the data processing module 14 is, according to the object information transmitted from the N-th information read-out device 102, configured for acquiring a plurality of test data of the test object 2 from a (N−1)-th one of the M SFC devices 1 that is connected to a (N−1)-th one of the M test machines 101 through the network communication interface 13. The plurality of test data comprises a data of test result of the test object 2, and also comprises test station name, test station number, flow Number, serial number (SN), testing time, device name, device IP address, and device MAC address.

Briefly speaking, before a current-stage (i.e., N-th) test machine 101 starts to execute an object testing for the test object 2, a current-stage (i.e., N-th) SFC device 1 would acquiring the test data of the test object 2 from a previous-stage (i.e., (N−1)-th) SFC device 1 through the network communication interface 13 thereof. Therefore, the verification unit 143 is adopted for applying a re-verification to a pass record from the data of test result that is contained in the received test data. Consequently, the current-stage (i.e., N-th) test machine 101 is informed and allowed to execute the object testing for the test object 2 in case of the pass record having indicated that the object testing executed by the previous-stage (i.e., (N−1)-th) test machine 101 is passed.

According to the present invention, the data processing module 14 of the SFC device 1 is provided with a memory therein, and the memory includes a recording unit 144 and a storage unit 145. As FIG. 0.1 and FIG. 2 show, the recording unit 144 is used for recording the object information that is read out by the information read-out device 102, and is also used for recording the plurality of test data that are received from the (N−1)-th one of the M SFC devices 1 that is connected to the (N−1)-th one of the M test machines 101. On the other hand, the storage unit 145 is used for storing the plurality of test data that comprise test station name, test station number, flow Number, serial number (SN), testing time, device name, device IP address, device MAC address, and the data of test result of the test object 2 that are generated by the N-th one of the M test machines 101.

It needs to particularly explain that, as FIG. 1 shows, a first one of the M test machines 101 is disposed at a feed-in stage 1 in of the production line 100, and a first one of the M SFC devices 1 that is connected to the first test machine 101 not applies the re-verification to the pass record from the data of test result during the test object 2 being transferred into the first test machine 101. In other words, the first one of the M test machines 101 disposed at the feed-in stage 1 in of the production line 100 is commonly an appearance inspection machine or a defect inspection machine, and is used for completing an appearance inspection or a defect inspection of the test object 2. In such case, the first SFC device 1 is set to not apply the re-verification to the pass record from the data of test result of the test object 2.

Moreover, FIG. 1 also depicts that a M-th one of the M test machines 101 is disposed at a feed-out stage of the production line 100, and a M-th one of the M SFC devices 1 that is connected to the M-th test machine 101 is set to acquires all of the test data of the test object 2 from the first SFC device 1 to a (M−1)-th SFC device 1 through the network communication interface 13 thereof, so as to apply the re-verification to all of the pass records from all of the test data before the test object 2 is transferred into the M-th test machine 101. By such arrangement, a finished product of the test object 2 is guaranteed to not have defects, and it can also make the appearance, thickness, functional performance, and electrical performance of the finished product of the test object 2 meet standards.

For the device management, setting and installing of each of the M SFC devices 1, as FIG. 1 shows, the externally-connected shop floor control system of the present invention further comprises a control center MED, which is coupled to the M SFC devices 1 through a wireless connection interface or a wired connection interface, so as to not only control an operation state of each of the M SFC devices 1, but also assist a manager of the production line 100 in data collection, station passing control, manufacturing reports, and control of production efficiency and yield based on all of the plurality of test data that are received from all of the M SFC devices 1. In other words, by implementing the externally-connected shop floor control system of the present invention into a production line 100, it is not only able to assist the manager of the production line 100 in recording and compiling information of raw materials, semi-finished products, products, machines, working hours, and costs, but also in the management of the production line in data collection, station passing control, manufacturing reports, and control of production efficiency and yield.

In one practicable embodiment, the control center MED is an application program installed in an electronic device, and the electronic device can be a desk central control electronic system, a cloud monitoring system, an industrial computer, a laptop computer, a smartphone, and a portable central control electronic system.

Any modification to the present invention made by a person skilled in the art does not depart from the protection scope defined by the appended claims.

What is claimed is:

1. An externally-connected shop floor control system, being applied in a production line having M test machines and M information read-out devices, wherein each of the M information read-out devices is adopted for reading out an object information from a test object that is transferred into one of the M test machines, and the externally-connected shop floor control system comprising:
M shop floor control (SFC) devices, wherein each of the M SFC devices is connected between one of the M information read-out devices and one of the M test machines, and comprising:
a first communication interface for being coupled to the information read-out device;
a second communication interface for being coupled to the test machine;
a network communication interface; and
a data processing module, being coupled between the first communication interface and the second communication interface, and being also coupled to the network communication interface; wherein there are a plurality of functional units provided in the data processing module, and the plurality of functional units comprising:
a device setting unit, being used for completing a parameter setting of the SFC device according to at least one machine information of the test machine;
a data acquiring unit, wherein before the test object is transferred into a N-th one of the M test machines for being executed an object testing, the data acquiring unit is, according to the object information transmitted from the information read-out device, configured for acquiring a plurality of test data of the test object from a (N−1)-th one of the M SFC devices that is connected to a (N−1)-th one of the M test machines through the network communication interface; wherein the plurality of test data comprising a data of test result of the test object; and
a verification unit, wherein before the N-th one of the M test machines starts to execute the object testing for the test object, the verification unit applying a re-verification to a pass record from the data of test result, such that the N-th one of the M test machines is allowed to execute the object testing for the test object in case of the pass record having indicated that the object testing executed by the (N−1)-th one of the M test machines is passed;
wherein both M and N are an integer, and M being greater than N.

2. The externally-connected shop floor control system according to claim 1, wherein each of the M test machines is selected from the group consisting of appearance inspection machine, defect inspection machine, thickness measurement machine, function testing machine, and electronic test machine.

3. The externally-connected shop floor control system according to claim 1, wherein the test object is a semi-finished product or a product.

4. The externally-connected shop floor control system according to claim 1, wherein both the first communication interface and the second communication interface comprise a wireless transmission unit and/or a wired transmission unit.

5. The externally-connected shop floor control system according to claim 1, wherein a first one of the M test machines is disposed at a feed-in stage of the production line, and a first one of the M SFC devices that is connected to the first one of the M test machines not applying the re-verification to the pass record from the data of test result of the test object that is transferred into the first one of the M test machines.

6. The externally-connected shop floor control system according to claim 1, wherein a M-th one of the M test machines is disposed at a feed-out stage of the production line, and a M-th one of the M SFC devices that is connected to the M-th one of the M test machines acquiring all of the test data of the test object from a first one of the M SFC devices to the (M−1)-th one of the M SFC devices through the network communication interface thereof, so as to apply the re-verification to all of the pass records of the test object that is transferred into the M-th one of the M test machines.

7. The externally-connected shop floor control system according to claim 1, wherein the plurality of test data of the test object further comprises test station name, test station number, flow Number, serial number (SN), testing time, device name, device IP address, and device MAC address.

8. The externally-connected shop floor control system according to claim 1, wherein the test object is provided with an information carrying member for carrying the object information thereon.

9. The externally-connected shop floor control system according to claim 8, wherein the information carrying member is selected from the group consisting of 1D barcode, 2D barcode, QR code, Hanxin code, data matrix code, RFID tag, NFC tag, 1D symbology, and 2D symbology.

10. The externally-connected shop floor control system according to claim 8, wherein the plurality of functional units provided in the data processing module further comprises a recording unit, being used for recording the object information that is read out by the information read-out device and the plurality of test data that are received from the (N−1)-th one of the M SFC devices that is connected to the (N−1)-th one of the M test machines.

11. The externally-connected shop floor control system according to claim 9, wherein the information read-out device is selected from the group consisting of 1D barcode reader, 2D barcode reader, QR code reader, Hanxin code reader, data matrix code reader, RFID reader, NFC reader, and camera.

12. The externally-connected shop floor control system according to claim 10, wherein the plurality of functional units provided in the data processing module further comprises a storage unit, being used for storing the plurality of test data that comprise test station name, test station number, flow Number, serial number (SN), testing time, device name, device IP address, device MAC address, and the data of test result of the test object that are generated by the N-th one of the M test machines.

13. The externally-connected shop floor control system according to claim 12, wherein the data processing module is provided with a memory therein, and the memory including the recording unit and the storage unit.

14. The externally-connected shop floor control system according to claim 12, further comprising a control center of the production line, being coupled to the M SFC devices through a wireless connection interface or a wired connection interface, so as to not only control an operation state of the M SFC devices, but also assist a manager of the production line in data collection, station passing control, manufacturing reports, and control of production efficiency and yield based on all of the plurality of test data that are received from all of the M SFC devices.

15. The externally-connected shop floor control system according to claim 14, wherein the control center is an application program installed in an electronic device.

16. The externally-connected shop floor control system according to claim 14, wherein the control center is selected from the group consisting of desk central control electronic system, cloud monitoring system, industrial computer, laptop computer, smartphone, and portable central control electronic system.
